(19) United States
(12) Patent Application Publication
(10) Pub. No.: US 2010/0166002 A1
(43) Pub. Date: Jul. 1, 2010

(54) SYSTEM AND METHOD OF CONNECTING TWO NETWORKS

(75) Inventors: Liang Gan, Beijing (CN); Yanning Bai, Beijing (CN); Joon Young Park, Libertyville, IL (US)

Correspondence Address: Motorola, Inc.;Law Department, 1303 East Algonquin Road, 3rd Floor, Schaumburg, IL, 60196, US

(73) Assignee: MOTOROLA, INC., Schaumburg, IL (US)

(21) Appl. No.: 12/347,001

(22) Filed: Dec. 31, 2008

(51) Int. Cl. H04L 12/56

(52) U.S. Cl. 370/401

(57) ABSTRACT

In accordance with an aspect of the present invention, a method is provided for establishing connection between a first local area network and a second local area network. The first local area network includes a first device and a second device. The second local area network includes a third device. The method comprises establishing a security connection between the third device and the first device; detecting a status of the second device; creating a virtual device based on the second device; and establishing connection between the second device and the third device via the virtual device.

### BACKGROUND

Conventional methods of communicating between two local area networks (LANs) will now be described with reference to FIGS. 1A and 1B.

FIG. 1A illustrates a LAN 102 and a LAN 104, each in communication with Internet 106.

LAN 102 includes a firewall 116, and a plurality of devices 108, 110, 112 and 114. Firewall 116 is an integrated collection of security measures designed to prevent unauthorized electronic access to LAN 102. Devices 108, 110, 112 and 114 are examples of devices that have network communication ability, non-limiting examples of which include computers, video display systems, audio systems, etc. Each of devices 108, 110, 112 and 114 may easily be configured to communicate with one another.

LAN 104 includes a firewall 118, and a plurality of devices 120, 122, 124, 126 and 128. Firewall 118 is an integrated collection of security measures designed to prevent unauthorized electronic access to LAN 104. Devices 120, 122, 124, 126 and 128 are examples of devices that have network communication ability, non-limiting examples of which include computers, video display systems, audio systems, etc. Each of devices 120, 122, 124, 126 and 128 may easily be configured to communicate with one another.

With conventional network communication systems and methods, any of 108, 110, 112 and 114 of LAN 102 may be configured to communicate with any of devices 120, 122, 124, 126 and 128 of LAN 104. For example, suppose device 108 of LAN 102 were to communicate with device 120 of LAN 104. In such a case, device 108 must know the Internet Protocol (IP) address of device 120. An IP address is unique numerical identification assigned to each device and is the primary identifier of each device within a network. Once known, device 108 would send a request to establish connection to the IP address of device 120. This request must be configured to pass firewall 116 of LAN 102, continue through Internet 106, pass firewall 118 and finally contact device 120 at the known IP address.

The level of difficulty of configuring any particular device to communicate with another device within the same LAN typically varies as function of the level of sophistication of the device. For example, conventional computers are typically very easy to configure to communicate with other devices within the same LAN, whereas a conventional video player may not be as easy to configure to communicate with other devices within the same LAN.

The level of difficulty of configuring any particular device to communicate with another device in another LAN typically additionally varies as a function of the level of sophistication of the device. However, as compared to configuring two devices to communicate with one another on a single LAN, configuring two devices on separate LANs to communicate with one another is typically more difficult. Further, some devices are harder, or more complicated, to configure with respect to communicating outside their LAN.

Devices may be added to an existing network. As alluded to above, newly added devices may be configured to communicate with devices within the LAN. Further, newly added devices may be configured to communicate with devices in other LANs. However, such configuration is typically more complicated than the configuration to communicate within a LAN.

Universal plug and play, or UPnP technology, is a set of computer protocols established by the UPnP Forum. The UPnP Forum is an industry initiative designed to enable simple and robust connectivity among consumer electronics, intelligent appliances and mobile devices from many different vendors. The primary goal of the UPnP Forum is to simplify the implementation of networks in home and corporate environments. This is accomplished by defining and publishing UPnP device control protocols built upon open, internet-based communication standards. UPnP technology operates independent of any operating system or programming language and can run on any device that supports the Internet Protocol including Ethernet, Bluetooth and Wi-Fi.

One application of UPnP technology is in home networks, although any network is capable of implementing UPnP technology. The Remote Access Working Committee (RAWC) is currently defining a set of UPnP services that enable UPnP devices in a remote network to connect to a home network and interact with UPnP devices physically connected to the home network. During this process it is expected that the user in the remote network can experience that the remote device behaving in a similar way as in the home network.

Conventional UPnP technology allows devices within a local area network (LAN) to easily communicate with other. FIG. 1B illustrates the addition of a UPnP device 126 being added to LAN 102. Once connected to LAN 102, as a result of the UPnP protocols, UPnP device 126 can communicate with any of devices 108, 110, 112, 114 and 116 within LAN 102 with little or no configuration. However, UPnP protocols do not easily address communication outside of a LAN. In particular, in this example, although newly added UPnP device 126 may easily communicate with any device within LAN 102, it may need configuration to communicate with any device in LAN 104. The level of complexity associated with this additional configuration may vary from UPnP device to UPnP device. A more detailed discussion of connecting a UPnP device to a LAN will now be discussed below.

The UPnP discovery step is achieved through Simple Service Discovery Protocol (SSDP). SSDP reconstruction is the key of UPnP Remote Access (RA) technology in the sense of most SSDP messages are a User Datagram Protocol (UDP) multicast message, where UDP messages cannot usually traverse the routers between home network and remote network.

Referring back to FIG. 1B, typically, one RAS (Remote Access Server) physical device resides at LAN 102, and a RAC (Remote Access Client) physical device that is a portable device outside of LAN 102. A RAS is a device that routes traffic to and from LAN 102. A RAC is a device that requests access to the RAS. In this example, let device 108 in LAN 102 be the RAS and let UPnP device 126 in LAN 104 be the RAC. The basic idea of the UPnP RA is that the status of any of devices 108, 110, 112, 114, and 116 in LAN 102 (designed through SSDP multicast way in traditional UPnP) is monitored by RAS 108 and forwarded from RAS 108 to RAC 126 in unicast way, and RAS 108 reconstructs the SSDP message on behalf of the other devices within LAN 102. Thus remote devices could “discover” any of devices 108, 110, 112, 114, and 116 in LAN 102.

FIG. 2 illustrates a remote access building up process. First, RAC 126 builds up the security connection with RAS 108 in LAN 102, through VPN technology. Then, when getting an IP address (hereafter, the IP address assigned from VPN will be named as “Virtual IP”) from a VPN server, any UPnP devices physically connected with RAC 126 in LAN 104 will switch to work in that Virtual IP. Then, RAS 108 in LAN 102 continuously detects the status of devices 108, 110, 112, 114, and 116 in LAN 102, and reporting these statuses to a remote device/control point. The reporting information includes the all necessary information for reconstructing a SSDP message, such as present/absent status, UUID, device type, configid, booted, etc. Then, RAC 126 in LAN 104 reconstructs the SSDP messages on behalf of any of devices 108, 110, 112, 114, and 116 in LAN 102 according to the messages reported from RAS 108 in LAN 102. Non-limiting examples of SSDP messages include SSDP: alive, SSDP: byebye, etc. It is important to note that the reconstructed SSDP messages are same as those from the delegating device in the home network: same IP address.

As discussed above, the UPnP RA enables a single remote UPnP Device or Control Point (CP) to connect to LAN 102 and interact with any of devices 108, 110, 112, 114, and 116 and other CPs physically connected to LAN 102.

When two or more UPnP technology networks merge together, the conventional UPnP RA is not applicable and more consideration is required. One important problem arises when multiple UPnP devices have the same IP address. In other words, a case where two UPnP technology networks use the same subnet and two or more UPnP devices in both networks happen to have same IP addresses.

Most consumers use popular low end routers, and popular or default subnet is 192.168.1.*. As such, when two IP networks are merged, it is very likely that the two IP networks will have the same subnet.

Returning to FIG. 1B, presume that device 112 in LAN 102 and device 126 in LAN 104 are popular low end routers, and therefore each have a default subnet as 192.168.1.*. Therefore, within each LAN, device 112 and device 126 may have an IP address of 192.168.1.2. When RAC 126 in LAN 102 sends a UPnP action to device 112 in LAN 102, wherein device 112 has IP address 192.168.1.2, the corresponding IP messages from RAC 126 can be captured by both device 112 in LAN 102 and device 126 in LAN 104, since bridging mechanisms simply replicate IP messages from LAN 102 to LAN 104.

What is needed is a method to enable a UPnP device in one LAN to communicate with a device in another LAN without additional configuration of the UPnP device.

### BRIEF SUMMARY

In accordance with an aspect of the present invention, a method is provided to enable a UPnP device in one LAN to communicate with a device in another LAN without additional configuration of the UPnP device.

In accordance with an aspect of the present invention, a method is provided for establishing connection between a first local area network and a second local area network. The first local area network includes a first device and a second device. The second local area network includes a third device. The method comprises establishing a security connection between the third device and the first device; detecting a status of the second device; creating a virtual device based on the second device; and establishing connection between the second device and the third device via the virtual device.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1A illustrates a first LAN and a second LAN, each in communication with the Internet;

FIG. 1B illustrates a UPnP device being added to the first LAN of FIG. 1A;

FIG. 2 illustrates a remote access building up process;

FIG. 3A illustrates a first LAN and a second LAN, each in communication with the Internet;

FIG. 3B illustrates a UPnP device being added to the first LAN of FIG. 3A; and

FIG. 4 illustrates an example process to merge a first LAN and second LAN in accordance with an aspect of the present invention.

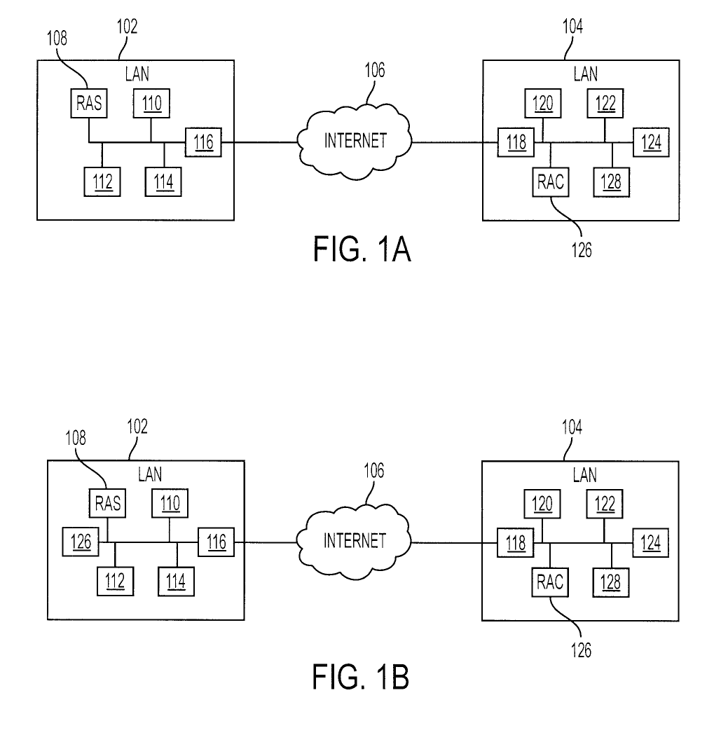

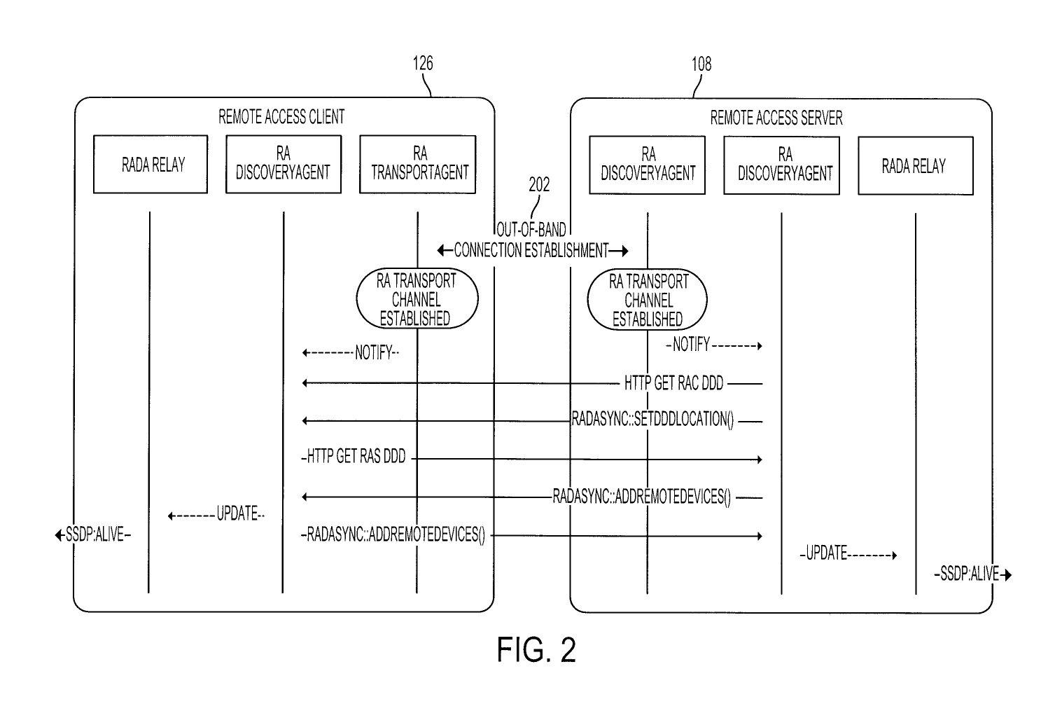

### DETAILED DESCRIPTION

An aspect of the present invention enables two or more UPnP technology networks to be merged. Both UPnP technology networks has a Remote Access (RA) device with both the RAS and the RAC functionality, where the either one of the RA device in two UPnP technology networks can initiate secure transport connection at any time.

In accordance with an aspect to the present invention any device in network 102 can easily communicate with any of the devices in network 104 as discussed in more detail below.

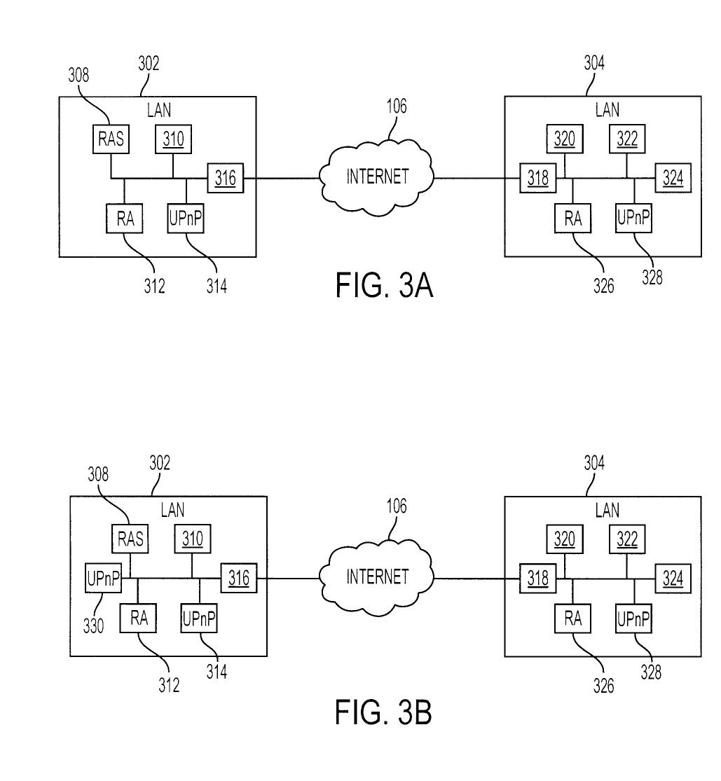

A network system in accordance with an aspect of the present invention will now be described with reference to FIGS. 3A and 3B.

FIG. 3A illustrates a LAN 302 and a LAN 304, each in communication with Internet 106.

LAN 302 includes a firewall 316, and a plurality of devices 308, 310, 312 and 314. Firewall 316 is an integrated collection of security measures designed to prevent unauthorized electronic access to LAN 302. Devices 308, 310, 312 and 314 are examples of devices that have network communication ability, non-limiting examples of which include computers, video display systems, audio systems, etc. Each of devices 308, 310, 312 and 314 may easily be configured to communicate with one another. Further, in this example, device 314 is a UPnP device and device 312 is a RA with both a RAS and a RAC functionality.

LAN 304 includes a firewall 318, and a plurality of devices 320, 322, 324, 326 and 328. Firewall 318 is an integrated collection of security measures designed to prevent unauthorized electronic access to LAN 304. Devices 320, 322, 324, 326 and 328 are examples of devices that have network communication ability, non-limiting examples of which include computers, video display systems, audio systems, etc. Each of devices 320, 322, 324, 326 and 328 may easily be configured to communicate with one another. Further, in this example, device 328 is a UPnP device and device 326 is a RA with both a RAS and a RAC functionality.

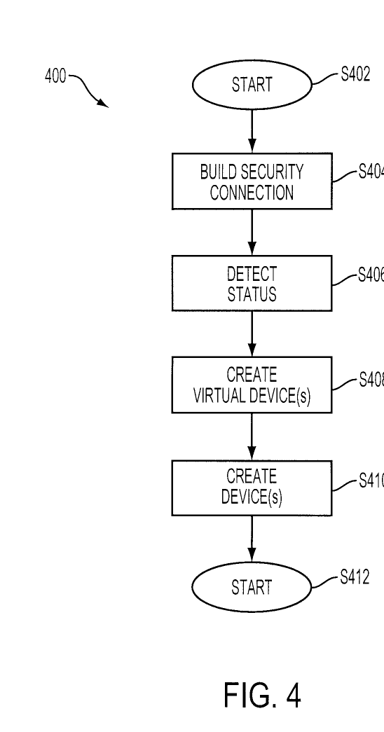

Assuming that LAN 304 initiates a remote access connection, an example process to merge LAN 302 and LAN 304 in accordance with an aspect of the present invention will now be described with additional reference to FIG. 4.

Once the process starts (S402), the RAC functionality of RA 326 in LAN 304 builds up a security connection with the RAS functionality of RA 312 in LAN 302 (S404), for an example, through virtual private network (VPN) technology.

Next, the RAS functionality of RA 312 in LAN 302 keeps on detecting the status devices within LAN 302, and reporting these status to all devices in LAN 304 through the RAC functionality of RA 326 in LAN 304 (S406). The status reported includes the all necessary information for reconstructing SSDP messages, such as present/absent status, UUID, device type, configid, booted, etc.

Then, the RAC functionality of RA 326 in LAN 304 creates, within RA 326, a virtual device for devices 308, 310, 312 and 314 in LAN 302 (S408). The IP addresses of those virtual devices are same as the native IP address of RA 326, and have nothing to do with original IP addresses of devices 308, 310, 312 and 314 in LAN 302.

Similarly, the RAS functionality of RA 312 in LAN 302 creates, within RA 312, a virtual device for devices 320, 322, 324, 326 and 328 in LAN 304 (S410). The IP addresses of those virtual devices are same as the native IP address of RA 312, and have nothing to do with original IP addresses of devices 320, 322, 324, 326 and 328 in LAN 304.

In the above discussed example embodiment, the virtual devices corresponding to devices 308, 310, 312 and 314 in LAN 302 are created in the RAC functionality of RA 326 in LAN 304 (S408) before the virtual devices corresponding to devices 320, 322, 324, 326 and 328 in LAN 304 are created the RAS functionality of RA 312 in LAN 302 (S410). In other embodiments, the virtual devices corresponding to devices 320, 322, 324, 326 and 328 in LAN 304 are created the RAS functionality of RA 312 in LAN 302 are created (S410) before the virtual devices corresponding to devices 308, 310, 312 and 314 in LAN 302 are created in the RAC functionality of RA 326 in LAN 304 (S408). In still other embodiments, the virtual devices corresponding to devices 308, 310, 312 and 314 in LAN 302 are created in the RAC functionality of RA 326 in LAN 304 at the same time the virtual devices corresponding to devices 320, 322, 324, 326 and 328 in LAN 304 are created the RAS functionality of RA 312 in LAN 302. In any event, the process is then complete (S412).

Since all the virtual devices are created within the RAC functionality of RA 326 in LAN 304 or the RAS functionality of RA 312 in LAN 302, they all have same IP address. Therefore, virtual devices within the RAC functionality of RA 326 in LAN 304 should use different port numbers from virtual devices within the RAS functionality of RA 312 in LAN 302. To do this, the RAC functionality of RA 326 in LAN 304 needs to get DDD/SCPD from devices 308, 310, 312 and 314 in LAN 302. This is done through http-get. Each virtual device may need to update some field of DDD/SCPD, such as IP address and port. Therefore, LAN 302 and LAN 304 are merged together. In other words, devices 308, 310, 312 and 314 in LAN 302 are all visible to devices 320, 322, 324, 326 and 328 in LAN 304.

Once a connection is established and virtual devices are created in each LAN, a new UPnP device may be easily added to either network, wherein the newly added UPnP device may easily communicate with devices within either network.

FIG. 3B illustrates the addition of a UPnP device 330 being added to LAN 302. Once connected to LAN 302, as a result of the UPnP protocols, UPnP device 330 can communicate with any of devices 308, 310, 312 and 314 within LAN 302 with little or no configuration. Further, once added, the RAS functionality of RA 312 in LAN 302, detects the status of UPnP device 330 and reports the status to the RAC functionality of RA 326 in LAN 304. RA 326 in LAN 304 then creates a virtual device corresponding to UPnP device 330. As discussed above, newly added UPnP device 330 may easily communicate with any of devices 320, 322, 324, 326 and 328 in LAN 304 via their corresponding virtual devices residing within the RA 312 in LAN 302. Further, any of devices 320, 322, 324, 326 and 328 in LAN 304 may easily communicate with newly added UPnP device 330 via its corresponding virtual device now residing in RA 326 in LAN 304.

The operation of control, eventing and out-of-band content transfer will now be discussed.

When a CP at LAN 304 invokes an action of a virtual device corresponding to device 308 in LAN 302 the virtual device leverages a supporting CP in the RAC functionality of RA 326 in LAN 304 to forward a Simple Object Action Protocol (SOAP) action to device 308 in LAN 302 through the connection from RA 326. When the virtual device gets the response, it will respond to the SOAP action. The process may include replacing the IP address of the virtual device in the parameter of the SOAP action, from the IP address of device 302 in LAN 302 to the IP address of the virtual device.

A UPnP description for a service includes a list of actions the service responds to and a list of variables that model the state of the service at run time. The service publishes updates when these variables change, and a CP may subsbribe to receive this information. The service publishes updates by sending event messages. This is termed event notification, or “eventing.” Event messages contain the names of one or more state variables and the current value of those variables. For eventing, the supporting CP in the RAC functionality of RA 326 in LAN 304 will fulfill it on behalf of CPs within LAN 304, and forward event notification from devices 308, 310, 312 and 314 within LAN 302 to virtual devices and then to CPs at LAN 304.

The virtual devices at LAN 304 may relay the content transfer between devices that reside in LAN 302 and LAN 304.

In the example embodiments discussed above, a device in each of LAN 302 and LAN 304 has RAS functionality and RAC functionality, and virtual devices are created in each LAN, wherein the virtual devices correspond to real devices in the other network. As such, two-way communication is established between all devices within LAN 302 and all devices within LAN 304. In other embodiments only one way communication is established. For example, in accordance with aspects of the present invention, a device in only one of LAN 302 and LAN 304 has RAS functionality and RAC functionality. Further in such embodiments, virtual devices are created only in the LAN having the device with RAS functionality and RAC functionality, wherein the virtual devices correspond to real devices in the other network. As such, one-way communication is established between devices within one of LAN 302 and LAN 304.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A method of establishing connection between a first local area network and a second local area network, the first local area network comprising a first device and a second device, the second local area network comprising a third device, said method comprising:
establishing a security connection between the third device and the first device;
detecting a status of the second device;
creating a virtual device based on the second device; and
establishing connection between the second device and the third device via the virtual device.

2. The method of claim 1, wherein said creating a virtual device based on the second device comprises creating a virtual device via the first device.

3. The method of claim 2, wherein said detecting a status of the second device comprises detecting a status of the second device via the first device.

4. The method of claim 3, wherein said detecting a status of the second device comprises detecting information corresponding to a device type.

5. The method of claim 2, wherein said detecting a status of the second device comprises detecting information corresponding to a device type.

6. The method of claim 1, wherein said detecting a status of the second device comprises detecting a status of the second device via the first device.

7. The method of claim 6, wherein said detecting a status of the second device comprises detecting information corresponding to a device type.

8. The method of claim 1, wherein said detecting a status of the second device comprises detecting information corresponding to a device type.

9. A method of establishing connection between a first local area network and a second local area network, the first local area network comprising a first device and a second device, the second local area network comprising a third device and a fourth device, said method comprising:
establishing a security connection between the third device and the first device;
detecting a status of the second device;
detecting a status of the fourth device;
creating a first virtual device based on the second device;
creating a second virtual device based on the fourth device;
establishing connection between the second device and the third device via the virtual device, and
establishing connection between the fourth device and the first device via the virtual device.

10. The method of claim 9, wherein said creating a first virtual device based on the second device comprises creating a first virtual device via the first device.

11. The method of claim 10, wherein said detecting a status of the second device comprises detecting a status of the second device via the first device.

12. The method of claim 11, wherein said detecting a status of the second device comprises detecting information corresponding to a device type.

13. The method of claim 10, wherein said detecting a status of the second device comprises detecting information corresponding to a device type.

14. The method of claim 9, wherein said detecting a status of the second device comprises detecting a status of the second device via the first device.

15. The method of claim 14, wherein said detecting a status of the second device comprises detecting information corresponding to a device type.

16. The method of claim 9, wherein said detecting a status of the second device comprises detecting information corresponding to a device type.

17. The method of claim 9, wherein said creating a second virtual device based on the fourth device comprises creating a second virtual device via the third device.

18. The method of claim 17, wherein said detecting a status of the fourth device comprises detecting a status of the fourth device via the third device.

19. The method of claim 18, wherein said detecting a status of the fourth device comprises detecting information corresponding to a device type.

20. The method of claim 17, wherein said detecting a status of the fourth device comprises detecting information corresponding to a device type.
